(19) United States
(12) Patent Application Publication
(10) Pub. No.: US 2012/0101867 A1
(43) Pub. Date: Apr. 26, 2012

(54) System for Automatic Assignment of Agents in Inbound and Outbound Campaigns

(76) Inventors: Stanislav V. Zgardovski, Concord, CA (US); Oleksiy M. Kolomoyskyy, Moraga, CA (US); Vitaliy Teryoshin, Danville, CA (US)

(21) Appl. No.: 12/911,360

(22) Filed: Oct. 25, 2010

(51) Int. Cl. G06Q 10/00

(52) U.S. Cl. 705/7.15; 705/7.14

(57) ABSTRACT

A workforce-management application is provided, resident on a digital medium, for reallocating human resources between two or more interaction-processing subsystems in a contact center. The application includes a state-monitoring application executable from the digital medium for monitoring the current volumes of interaction requests pending in all of the currently active subsystems, a logic function executable from the digital medium by the state-monitoring application, the logic function adapted to determine what specific human resources with the required skills are needed to satisfy the current interaction processing requirements, and a communication and notification function for communicating the determinations of the logic function between one or more subsystems and for notifying individual ones of the affected human resources about the activity changes before they are set to occur.

### BACKGROUND OF THE INVENTION

1. Field of the Invention

The present invention is in the field of telephony including data network telephony and Internet protocol network telephony and pertains particularly to methods and apparatus for managing human resources when required to handle unexpected interaction loads.

2. Discussion of the State of the Art

In the art of telephony as related to commerce, contact centers are in place to service organizations that sell products and services to consumers. State-of-the-art contact centers have evolved from typical telephone call-in centers to multi-media centers that use a variety of communications applications to conduct business.

Many contact centers today operate in blended mode meaning that they can simultaneously process inbound and outbound transactions. Inbound refers to transactions coming in. Outbound refers to outgoing transactions, which are typically orchestrated by planned campaigns to a “calling list”. A challenge with operating in both modes simultaneously is making optimal use of the contact center agents.

Often contact center agents are statically divided between handling unsolicited inbound traffic and traffic solicited by outbound campaigns. In some cases, some subset of the agent resources is designated for processing interactions of all types and those interactions are delivered to the agents in a mixed mode. Both of these approaches in routing can be problematic.

Static agent resources division is not generally well adapted to irregularities in the contact center traffic such as with peak and lax periods of unsolicited inbound traffic. Agents working in mixed mode may suffer from an effect called agent swinging, which is a condition where the agent is switching back and forth between interaction types too frequently.

Outbound campaigns can be practiced in a predictive mode where transactions are initiated, such as calls placed, on a prediction of agent availability to handle responses to the outbound transactions. In the instance of telephony, where the outbound transactions are telephone calls, a predictive dialing algorithm places outbound calls at a frequency that depends on parameters of the campaign, such as the availability, whether real or predicted, of suitable agents to respond to successful calls. When agents are in mixed mode, the outbound campaign engine cannot always compensate for frequent unavailability of agents who are required to handle spikes in inbound traffic. When special requirements or talents of particular agents come into play, such as a need for a foreign language-speaking agent to handle certain calls, the mixed mode routing regimen becomes even more complex to manage.

Therefore, what is clearly needed is an automated contact-center system that allows one interaction-processing subsystem to automatically manage the services of specific agents or equivalents having specific skill sets working another interaction-processing subsystem when the need for those agents arises.

### SUMMARY OF THE INVENTION

The problem stated above is that agent availability and flexibility is desirable for a state-of-art contact center, but many of the conventional means for creating agent flexibility, such as reassigning agents between inbound and outbound campaigns, also create an undesirable “agent swinging” effect characterized by the constant switching of the agent between activities. The result is lower overall event handling quality for that agent. The inventors therefore considered functional components of a contact center, looking for elements that could potentially be harnessed to provide a more flexible agent workforce but in a manner that would not create lower quality due to rapid assignment and reassignment.

Every contact-center has peak periods characterized by more incoming calls than can be successfully handles using the originally assigned agents. One by-product of peak periods in a contact center is an abundance of customers who must wait in queue for an available agent. Most such contact centers employ more than one interaction processing subsystem to conduct the business of helping customers and routing systems, agent queues, and statistics servers are typically a part of such apparatus.

The present inventors realized in an inventive moment that if interaction processing subsystems in a contact center could, based on need, lay claim to specific agents having particular skills who may be working a lower priority tasks for a specified amount of time, significantly shorter wait times in queue and better quality interaction handling might result. The inventor therefore constructed a unique workforce-management application for use between two or more interaction processing subsystems in a contact center that allowed any interaction processing subsystem to lay claim to one or more specified agents for a specific period of time. A significant downturn in queue waiting time during peak periods of interaction processing resulted with no impediment to interaction handling quality or call flow efficiency.

Accordingly, in one embodiment of the present invention, a workforce-management application resident on a digital medium for reallocating human resources between two or more interaction-processing subsystems in a contact center is provided, including a state-monitoring application executable from the digital medium for monitoring the current volumes of interaction requests pending in all of the currently active subsystems, a logic function executable from the digital medium by the state-monitoring application, the logic function adapted to determine what specific human resources with the required skills are needed to satisfy the current interaction processing requirements, and a communication and notification function for communicating the determinations of the logic function between one or more subsystems and for notifying individual ones of the affected human resources about the activity changes before they are set to occur.

In one embodiment the interaction-processing subsystems include at least one subsystem dedicated to processing unsolicited inbound interaction requests and one or more subsystems dedicated to processing inbound requests resulting from an outbound campaign. Also in one embodiment the human resources are skilled contact-center agents. In that case the one or more subsystems dedicated to processing inbound requests resulting from an outbound campaign may be an outbound telephone campaign.

Also in one embodiment the digital medium is coupled to an interaction request-distribution server. The subsystem dedicated to processing inbound interaction requests may be a telephone switch that is computer telephony integrated (CTI) and enhanced for routing by a routing server. In one embodiment the incoming interaction requests may be calls arriving to the contact center from a Website on the Internet and from the Public-Switched-Telephone-Network (PSTN).

In some cases the incoming interaction requests are one-on-one chat requests arriving from a Website, and in others the outbound interaction requests may be proactive outbound chat requests from the contact-center to a Website.

In another aspect of the invention a method for reallocating human resources from servicing one interaction-processing subsystem to service another interaction-processing subsystem in a contact center is provided, comprising the steps of (a) monitoring the states of the active interaction-processing subsystems in the contact center; (b) detecting an irregularity in state of one or more of the interaction-processing subsystems; (c) determining the numbers and skills requirements relative to reallocate-able human resources in the contact center that would be required to correct the irregularity or irregularities detected in step (b); and (d) communicating the determination of (c) to the appropriate interaction-processing subsystem or subsystems as a request and notifying the individual ones of the human resources to be reallocated of the pending activity changes before they occur.

In one embodiment one subsystem is dedicated to processing inbound interaction requests and one or more subsystems are dedicated to processing interaction requests resulting from an outbound campaign. Also in one embodiment he human resources are skilled contact-center agents. In another embodiment, in step (a) monitored state includes the current numbers of pending interaction requests queued for processing by human resources under that subsystem. Also in an embodiment, in step (b), the irregularity is a sudden or predicted increase in volume of inbound interaction requests arriving at the contact center. The determination may be made by logic against a set of business rules and statistics available about reallocate-able human resources.

In some cases the subsystem dedicated to processing inbound interaction requests is a telephone switch that is computer telephony integrated (CTI) and enhanced for routing by a routing server. In other cases the one or more subsystems dedicated to processing outbound interaction requests may be an outbound telephone campaign. The communication may be brokered by a statistics server.

In some embodiments the incoming interaction requests are calls arriving to the contact center from a Website on the Internet and from the Public-Switched-Telephone-Network (PSTN), while in others the incoming interaction requests may be one-on-one chat requests arriving from a Website.

### BRIEF DESCRIPTION OF THE DRAWING FIGURES

FIG. 1 is an architectural overview of a communications network that supports resource claiming and temporary reassignment of duties based on a trigger event according to an embodiment of the present invention.

FIG. 2 is a process flow chart illustrating steps for claiming one or more resources for temporary use according to the embodiment of FIG. 1.

FIG. 3 is a united modeling language sequence diagram illustrating a process for reallocating one or more agents according to demand.

FIG. 4 is a block diagram illustrating interaction between the basic components of the work force application of FIG. 1.

FIG. 5 is a table illustrating a message that might be sent to lay claim to one or more agent resources working on a lower priority task in the contact center.

### DETAILED DESCRIPTION

The inventors provide a system for automatically managing one or more specified human resources in a contact-center environment based on trigger events. The present invention is described in enabling detail using the following examples, which may describe more than one relevant embodiment falling within the scope of the present invention. The examples are primarily involved with telephony systems, both PSTN and IPNT, but it should be understood that there may be embodiments involved with such as emails, chat systems, and text-messaging systems as well.

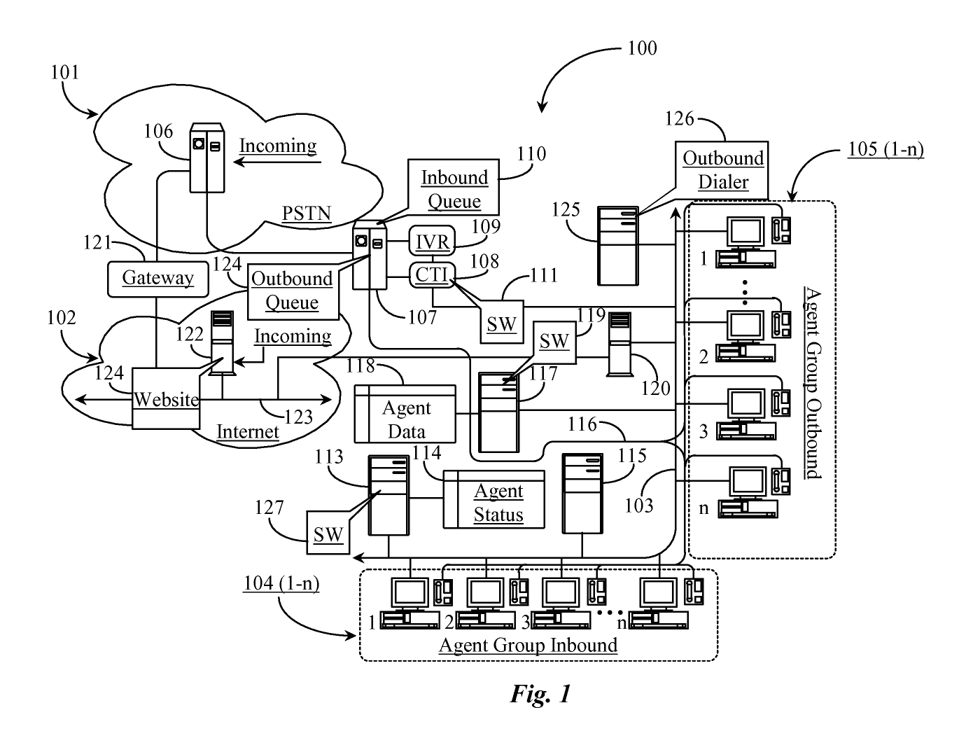

FIG. 1 is an architectural overview of a communications network 100 that supports resource claiming and temporary reassignment of duties based on trigger events according to an embodiment of the present invention. Communications network 100 includes a public switched telephone network (PSTN) 101, an Internet network 102, and a contact center represented herein as an aggregation of equipment and resources connected to a local area network (LAN) 103. LAN 103 is enhanced with transfer control protocol over Internet protocol (TCP/IP) and other Internet protocols required to enable LAN 103 to function as a subnet to Internet network 102.

Internet 102 is further represented herein by a network backbone 123. Network backbone 123 represents all of the lines, equipment, and connection points that make up the Internet as a whole. Therefore, there are no geographic limitations to the practice of the present invention. Internet backbone 123 supports a Web server 122 for hosting Websites for companies doing business over the Internet network. Web server 122 includes a digital medium coupled thereto or otherwise accessible that contains all of the data and software to enabled function as a Web server. Web server 122 has a Website 124 hosted thereon. Website 124 represents a company or enterprise Website through which transacting may be conducted between customers of the enterprise and a contact center represented by the equipment and resources connected to LAN 103. An arrow leading into Web server 122 labeled incoming represents customers accessing Website 124. Website 124 may contain a contact feature for enabling voice calls to be placed from the Website and a contact feature enabling live chart requests to be placed from the Website.

PSTN 101 includes a network telephone switch 106 for accepting incoming calls. An arrow labeled Incoming within PSTN cloud 101 represents any customers or potential customers who call into the contact center from anywhere in the PSTN network. Other communications carrier networks such as wireless cellular networks might also be considered in the example without departing from the spirit and scope of the present invention.

Network switch 106 has connection by telephone trunk to a contact-center switch 107 set up within the domain of the contact-center system. Contact-center switch 107 as well as network-based switch 106 may be automated call distributor (ACD), or private branch exchange (PBX) type switching facilities without departing from the spirit and scope of the present invention. Contact-center switch 107 may be a soft switch implemented in software in some embodiments. Switch 107 is enhanced for routing intelligence using a computer-telephony-integrated (CTI) processor 108. Processor 108 has connection to LAN 103 and is connected to switch 107 via a CTI link. Switch 107 represents the last hop before incoming interactions are routed to contact-center agents working within the center. An interactive-voice-response (IVR) unit 109 is provided to screen customers and to initiate routing regimens for routing the interaction requests to appropriate agents. IVR 109 is connected directly to switch 107 and also to CTI processor 108.

LAN 103 supports two agent groups in this example. These agent groups are agent group 104 (1-n), and agent group 105 (1-n). Agent group 104 (1-n) is dedicated to working the inbound calls. Inbound calls are queued, if no agents are currently available, in an inbound queue 110. Calls in inbound queue 110 may be such as a request to speak to a live agent on the phone. Inbound traffic usually retains a higher priority for answering than do some other types of transactions. Therefore, it is more important to the contact center that unsolicited inbound traffic be handled within the allowed estimated wait time in queue.

Switch 107 also includes a queue 124. Queue 124 represents an inbound queue for solicited contacts. For example, the contact center makes outbound calls to customers by outbound campaigns, and those customers that agree to be serviced by a live agent are routed to the outbound agent group. The designation as an outbound call simply refers to the fact that that pending call was solicited by an ongoing outbound campaign. In one embodiment all pending calls may be queued in the same queue with calls resulting from outbound campaigns marked to differentiate them from unsolicited inbound traffic. Often the calls from outbound campaigns have less priority than inbound interactions simply because they were solicited and have lower probability of successful conclusion.

PSTN 101 and Internet network 102 are bridged for cross communication using a network gateway 121. Gateway 121 may be any type of gateway that enables conversion of the communication from one format native to one network to another format native to the other network the communication is routed on. An SS7 gateway represents one such gateway type. Data requests and Voice over Internet protocol (VoIP) requests may be routed from Website 124 into the contact center through an Internet protocol router 120 connected to LAN 103. Router 120 has connection to backbone 123 via an Internet access line.

Agent group 104 (1-n) is represented by a plurality of agent stations 1-n comprising basically a personal computer and a telephone at each station. In this embodiment, agent group 105 (1-n) uses agent stations that are similar to or identical to those used by group 104. Telephones in this example have connection to contact-center switch 107 via internal telephony wiring 116. In another embodiment telephones may be connected directly to LAN 103 or each computer may host a telephony application and headset for use in contact center communications. For chat requests, the computers would host a chat application, perhaps part of an agent desktop application (not illustrated) installed on each agent's desktop. A chat server is not illustrated in this example, but may be assumed present and connected to LAN 103.

LAN 103 supports an outbound contact server 125. Contact server 125 includes a digital medium coupled thereto or otherwise accessible that contains all of the data and software to enable function as an outbound contact server. Outbound contact server 125 hosts an outbound dialing application 126. Outbound dialing application 126 is adapted to serve dialing instruction to contact-center switch 107 for dialing out to customers or potential customers as part of an active outbound calling campaign. Outbound contact server 125 is programmable to dial according to one of several available dialing modes. One of these dialing modes is called predictive dialing mode in the art.

One of the aspects of predictive dialing is that the dialing frequency takes into account historical availability patterns of agents and makes predictions about their becoming available to take dialed calls. Outbound dialing server 125 aided by CTI processor 108 and IVR 109 calls persons from a contact list and the frequency of dialing is dependent on the number of agents working the campaign and what percentage of those agents can be considered available to handle calls during the campaign. Connected outbound calls are routed back to agents as inbound interaction requests.

LAN 103 supports a universal routing server 115. Routing server 115 includes a digital medium coupled thereto or otherwise accessible that contains all of the data and software required to enable the function of a routing server. Universal in the name universal routing server means that the routing server can provide routing strategy for any type of routable interaction request. Universal routing server 115 provides routing strategy through CTI processor 108 to switch 107. LAN 103 supports a statistics server 113 that is adapted to serve contact-center statistics to automated systems and human resources within the contact center. Outbound dialing server 125 and routing server 115 may subscribe to statistics server 113 to enable statistical-based routing routines and predictive dialing routines that depend on statistics for guidance. Statistics server 113 has connection to a data repository 114 adapted to contain statistical information about agents and their status and performance in the contact center environment.

LAN 103 supports a workforce management server 117. Workforce management server 117 has a digital medium coupled thereto or otherwise accessible that is adapted to contain all of the data and software to enable function as a workforce management server. Workforce management server 117 contains among other things, the complete and current information about all of the agents working within the contact center and all of the schedules for those agents for working periods or shifts at the contact center. Workforce management server 117 has connection to a data repository 118 that is adapted to contain agent data such as scheduling data, skills data, language speaking data, and other data pertinent to scheduling a workforce in the contact center. In this particular example, inbound calls are being handled at the same time that at least one outbound campaign is running and generating calls.

Workforce management server 117 hosts software (SW) 119. SW 119 is part of a workforce management application that enables an interaction-processing subsystem to lay claim to one or more human resources regardless of where they are currently working within the contact center. SW 119 comprises the business logic portion of a larger application, which in this example is distributed to more than one machine or server. Software (SW) 111 is provided on CTI processor 108 as a queue monitoring application. Queue monitoring is an essential part of the contact center operation. SW 111 is adapted to provide current queue data such as estimated call-handling time, estimated wait time for interactions in queue, and like information. SW 111 may be pre-existing software resident on a digital medium such as on CTI processor 108, or it may be a component of a larger workforce management application of the present invention without departing from the spirit and scope of the present invention.

Statistics server 113 hosts software (SW) 127. SW 127 may be a communication and notification component of a larger workforce management application. SW 127 is adapted to generate a communication referred to as a claim signal in this specification. A claim signal represents a message that specifies a need for one or more additional human resources to join an existing activity such as answering incoming calls. SW 127, SW 119, and SW 111 may be resident on a single digital medium of one machine without departing from the spirit and scope of the present invention. In this example, the application is distributed to servers in the center that are involved in processing and serving information relative to resource claims that may be made by a system.

In use of the present invention, SW 111 actively monitors queues 110 and 124 at telephone switch 107. Queue 110 belongs to an inbound interaction-processing subsystem and is being worked by agents in agent group 104 at stations 1-n. Queue 124 belongs to an outbound interaction-processing subsystem and is being worked by agents in agent group 105 at stations 1-n. In a typical application, the inbound queue 110 carries more priority than queue 124 relative to contact-center policies and goals. For example, during a peak period where there are many calls incoming to queue 110, the estimated wait time may increase due to not enough agents on-hand to handle the added call load. With higher estimated wait times in queue, more calls are abandoned and more callers opt for self-service options as described further above in the background section of this specification.

SW 111 may determine that too many calls are in queue with no agents available in agent group 104 to bring the queue back into compliance with policy. SW 111 communicates this state to SW 119. SW 119 is the business logic required to determine the number of agents with specific skill levels that are required to bring the wait time in queue back down to compliance and how long that will take. Workforce server 117 subscribes to statistics server 113 and obtains all of the current statistics required to make a decision about what additional resources will be required and about when and for how long the additional resources will be required before they can be released back to original duties.

In one embodiment where transactions of many different types may come into the center, SW 119 may determine what will be required in additional resources by examining each of the interactions queued, one interaction at a time. In a more structured environment all of the incoming calls might expect to be the same type of call that can be handled by any agent with a specific level of skill. In one embodiment SW 119 may provide a list of qualified agents that can be forwarded to the interaction-processing sub-system that expects to give up one or more agents working a campaign for a given period of time. In one embodiment SW 119 may specifically target agents by identification number and generate a list of the exact agents they will require. It will be apparent to one with skill in the art of telephony communications that the level of granularity for determining and quantifying a need for additional resources, as well as possibly identifying the exact resource or resources desired, depends at least in part on the nature of the business being conducted.

Once a determination is made that identifies what is needed and for how long, SW 119 may communicate the need requirement to SW 127 running on statistics server 113. This is optional and not specifically required in order to practice the present invention. SW 119 or SW 127 may generate a machine-to-machine message also referred to herein as a “claim signal” to any interaction-processing subsystem in the call-center environment, such as an outbound campaign worked by agent group 105 (1-n). All of the interaction-processing subsystems subscribe to statistics from statistics server 113. In this regard, statistics server 113 is a convenient machine for hosting SW 127 for generating and propagating the claim signal.

SW 127 may also be responsible for pushing notifications to individual ones of agents that reassignment to working inbound interactions is pending. Such notifications may be embodied by an audio/visual message or indication that appears on each of their computing screen. In a preferred embodiment, the determination or assessment of the amount of human resources and skills ratings required to handle the increased number of interactions also estimates how long those resources will be occupied. Therefore, the claim signal will request a sufficient number of skilled resources to reduce the estimated wait time for callers in queue in a timely manner so those resources might be returned to their original tasks, which although lower in priority, still require efficient processing.

The parameters governing how human resources are shared may vary somewhat. For example, inbound traffic might be well handled by the existing agents working the inbound queue or queues but when a sudden influx of calls from Spanish-speaking callers arrives there are not enough Spanish-speaking agents to handle the calls. In this case, the inbound interaction-processing subsystem may lay claim to one or more additional Spanish-speaking agents that are currently working some other task. The most likely trigger event that would result in claim signal generation is a high estimated wait time in queue caused by a rise in inbound traffic.

In one embodiment of the present invention, the interaction-processing subsystem that has to give up one or more agents to another interaction-processing subsystem will retain the right to select which agent or agents will be released from current tasks and reassigned to the requesting subsystem. In one embodiment, where all of the agents are adequately trained to handle any type of interaction, the agents that are reassigned may be agents who are currently the lowest performers in their current tasks. In another embodiment agent trading may occur where an agent that is performing well in a lower-priority campaign might be traded to a higher-priority campaign for a lower performing agent working the higher-priority campaign.

The example of FIG. 1 illustrates a single inbound interaction-processing subsystem and a single outbound interaction-processing subsystem as systems that can claim human resources. However, in actual practice there may be many different inbound and outbound interaction-processing subsystems working within the contact center at any given period. One with skill in the art of workforce management will appreciate that human resources may be claimed across campaign types and interaction classes. For example, a proactive chat invitation campaign may be underway at Website 124 whereby chat invitations are sent to Website visitors. Inbound traffic at the telephone switch may peak causing a higher wait in queue. The inbound system may lay claim to one or more agents working chat. In one embodiment human resources may be taken from another department that does not traditionally process interactions in certain extreme situations where specific skills are required and there is a shortage of those skills.

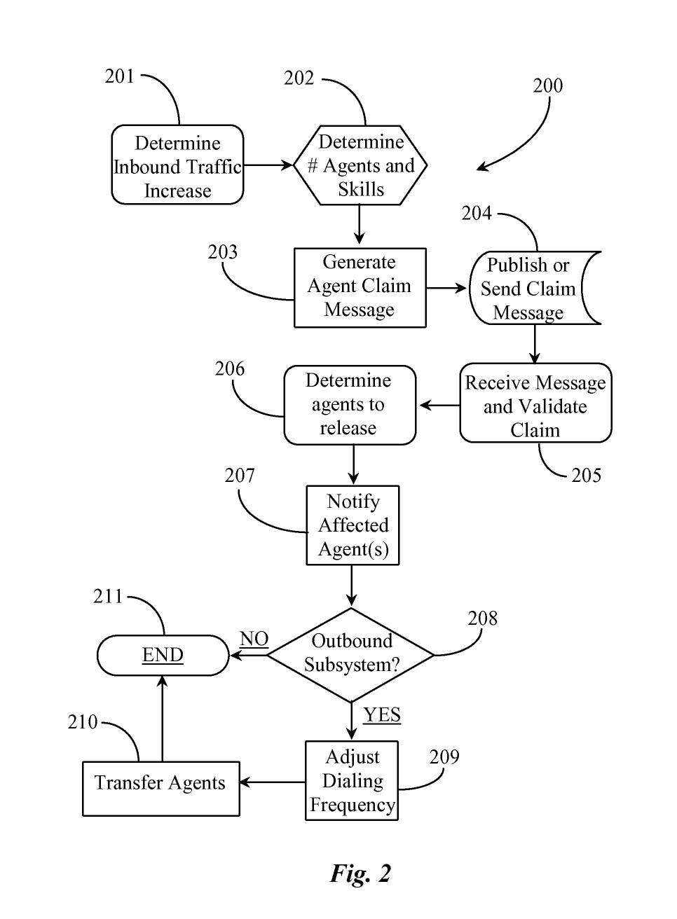

FIG. 2 is a process flow chart 200 illustrating steps for claiming one or more resources for temporary use according to the embodiment of FIG. 1. At step 201, queue-monitoring software determines there is an increase in inbound traffic pushing the wait time in queue beyond an acceptable threshold. In one embodiment existing queue monitoring applications such as CTI monitor software could be adapted to trigger the determination logic. At step 202, determination logic assesses the number of agents and the correct skills or skills rating required to adequately handling the influx of interactions. In one embodiment each interaction waiting in queue at the time of assessment shall be analyzed as to the specific skills required to handle the interaction.

The system generates a claim message or signal at step 203. The claim signal may list specific agents by identification number or name. In one embodiment the claim signal does not specifically name any agents but declares the type of agents and skills rating of the agents required to handle the extra interactions. The interaction-processing subsystem that receives the claim signal may be allowed to select which agents will ultimately be reallocated to the inbound system. In another embodiment the claim signal includes a complete list of qualified agents for the subsystem to select from.

A claim signal may be published or sent to one or more targeted interaction-processing subsystems at step 204. In one embodiment, the claim signal is broadcast and all other running interaction-processing subsystems receive the broadcast and respond by listing the human resources that those particular subsystems are willing to lend. In this case a step might be introduced for the requesting system to select from what is offered by all of the subsystems polled. For example, one agent could be reallocated from as many subsystems running

The claim signal may be an XML message, an http request, an RPC call or some other machine-readable format. At step 205, the targeted subsystem or subsystems receive the claim signal and acknowledge whether they can provide one or more of the total human resources required. For example, rules may prevent a subsystem from providing human resources beyond what is reasonable to efficiently manage the interactions being processed by that system. For example, the inbound system might claim 3 agents whereas an outbound campaign only has 3 agents working the queue, but another outbound campaign has 2 and one-half agents working its queue. The claim might be satisfied, for example by the first system giving up 1 and one-half agents while the second campaign gives up 1 and one-half agents totaling three agents borrowed from both outbound campaigns. Dialing frequencies are adjusted for each outbound campaign to compensate for the release of the human resources.

At step 206, the subsystem or systems determine the human resources that will be reassigned. At step 207 the affected agents receive notification that they will be reassigned. Such notification may be a pop-up message with audio and visual indication that the agent will begin processing interactions according to the claim signal. In one embodiment, notifications indicate a time when the reassignment will occur. In another embodiment, the agent will begin to receive interactions from the claiming subsystem with an indication of interaction type received just before the first routed interaction rings at the agent's workstation. In still another embodiment a claim signal embodies a prediction of a future need for human resources. In this case a subsystem targeted with a predictive claim signal may project what agents it may lend to the claiming system at that time period in the future, assuming the system will still be running then.

At step 208 it is determined whether the system supplying the claimed resources is an outbound contact system that uses an automatic dialing application with an adjustable dialing rate. If at step 208 the subsystem supplying the resources is not such a system, then the process may end at step 211. However, if it is determined at step 208 that the supplying system is an outbound contact system that automatically adjusts dialing rate, then the dialing rate in a preferred embodiment is adjusted at step 209, prior to transferring resources. After the adjustment in this embodiment agents are transferred at step 210.

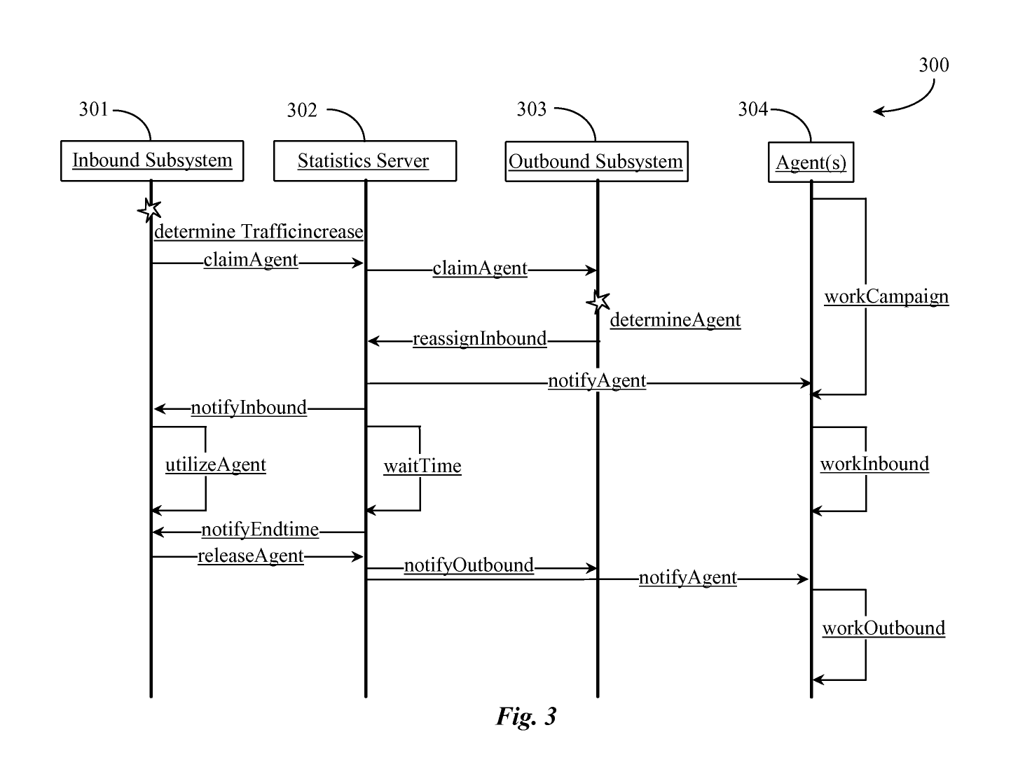

FIG. 3 is a united modeling language sequence diagram 300 illustrating a process for reallocating an agent according to a trigger event. In this example, an inbound subsystem 301 uses a queue monitoring application to determine a traffic increase (determine Trafficincrease). Assuming an increase in traffic beyond an acceptable threshold, inbound subsystem 301 generates a claim signal to claim an agent. The claim signal is propagated to a statistics server 302. Statistics server 302 forwards the claim signal to outbound subsystem 303. Statistics server 302 brokers communication in this example because all of the subsystems subscribe to statistics. In this case the statistics server receives the claim signal and makes it available immediately to subscribers to statistics from the server including outbound subsystem 303. In one embodiment the claim signal is generated in a workforce management server and then distributed to the outbound system 303 through statistics server 302.

Outbound subsystem 303 determines (determinAgent) which agent working the queue will be a suitable prospect for fulfillment of the claim from the requesting system based on analyzing the parameters of the claim signal against the skills and parameters of the agents working that outbound subsystem. Once subsystem 303 has determined which agent it will release, it reassigns (reassignInbound) the agent to work for the requesting inbound subsystem by notifying statistics server 302 of the pending reassignment. Statistics server 302 may then notify the selected agent (notifyAgent) by pushing a screen pop to that agent's screen or by calling the agent. The agent is notified of the pending reassignment before inbound interactions are routed to that agent as a courtesy and to insure a smooth transition. In one case the agent may be busy working a transaction at the time of reassignment. The statistics server also notifies inbound subsystem 301 (notifyInbound) of the confirmed reassignment.

Once the confirmation is received by the inbound subsystem, the subsystem begins utilizing the agent (utilizeAgent). The time that the agent is utilized is specified in the claim signal and most likely is at least 300 seconds to prevent the agent swinging phenomena described earlier in this specification. The utilization time is roughly the same period as a wait time (waitTime) the statistics server 302 waits before notifying the inbound subsystem of the end time (notifyEndtime), which is the point in time that the inbound subsystem no longer requires the agent as indicated in the original claim signal. In this way the inbound subsystem can make a decision whether to release the agent at that time or to retain that agent for an additional period of time. In order to retain the agent, a second claim signal may be required.

The claim signal specifies at minimum a number of human resources, the required skills definition, level, or rating of those human resources, when those resources are needed, how long those resources will be used, and the current task priority level under which agents may be released from any task to fulfill the claim. In one embodiment, the claiming subsystem may determine to keep one or more claimed resources if conditions warrant. For example, a projected need time may be stated, however, inbound traffic may continue to spike for some unknown reason requiring retention of claimed agents longer than was stated in the claim signal sent out to the other subsystems.

Inbound subsystem 301 releases (releaseAgent) the claimed agent, in this example, upon receiving notification (notifyEndtime) of the end of the period the agent has been utilized to answer inbound interactions. Statistics server 302 receives the release notification and notifies outbound subsystem 303 that the agent is no longer being utilized and is released from duty by the inbound subsystem. Statistics server 302 then notifies the agent that the agent is released from inbound interaction processing. The agent may then immediately return to processing interactions (workOutbound) from the outbound subsystem. Short periods between assignments allow the agent to prepare for the next task or duty.

In this example, outbound subsystem may be using a predictive dialing application to place outbound calls based on agent availability. Therefore, the outbound system may readjust the number of the agents in the pool to recalculate the rate of dialing so no calls are lost or abandoned during absence of the reassigned agent. The dialing application may wait 20 seconds or so to ensure that no outbound calls that are answered and in route to the center will be abandoned because of the loss of one or more agents to the inbound subsystem. Moreover, in the case of increased traffic intensity, the assignment activity may be rolled back when it is determined that the interaction load has returned to normal. In this case, the release-agent step may not be a decision made by the claiming subsystem, rather by the statistics server upon noting the normal traffic.

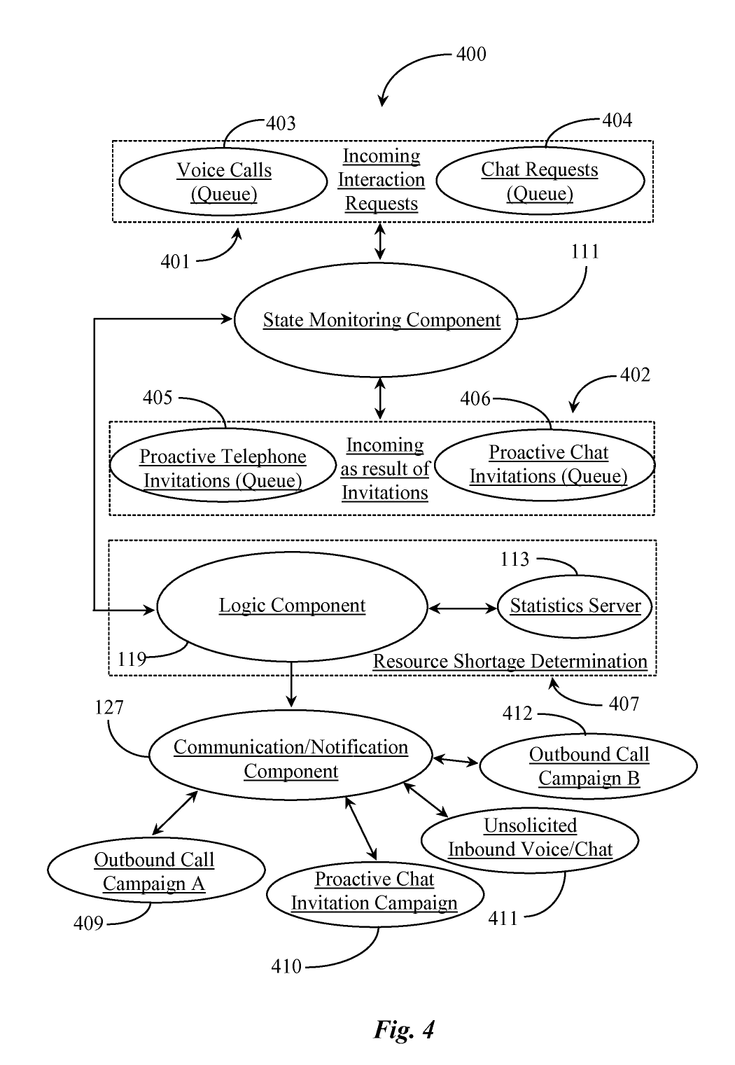

FIG. 4 is a block diagram 400 illustrating interaction between the basic components of the work force application of FIG. 1. In this example, incoming interaction requests 401 are characterized more particularly as voice calls in queue 403 and as chat requests in queue 404. Incoming interaction requests 401 are considered incoming to an inbound interaction-processing subsystem. State monitoring component 111 monitors the states of queues 403 and 404. State monitoring component 111 is analogous to SW 111 on CTI processor 108 of FIG. 1. Incoming interaction requests 402 are incoming as a result of invitations and are more particularly characterized as voice calls in queue 405 resulting from proactive telephone invitations and as chat requests in queue 406 resulting from proactive chat invitations. Incoming interaction requests 402 are considered incoming into an outbound interaction-processing subsystem.

Logic component 119 is analogous to SW 119 of FIG. 1 running on workforce management server 117. Logic component 119 with the aid of statistics server 113, also of FIG. 1 may make a resource shortage determination 407 with respect to available resources for working any of the queues. The logic component communicates with communication and notification component 127 analogous to SW 127 running on statistics server 113 in FIG. 1. Component 127 is responsible for communication and notification. In this example, component 127 communicates directly with outbound call campaign A (409); a proactive chat invitation campaign 410; unsolicited inbound campaign 411 for voice and chat; and outbound call campaign B (412).

State monitoring component 111 monitors all of the queues and communicates state to logic component 119. Aided by statistics server 113, logic component 119 creates a determination as to what exactly is required in the way of human resources and skills to alleviate any unacceptable wait times in any of the queues in a manner that still successfully disposes of the interactions.

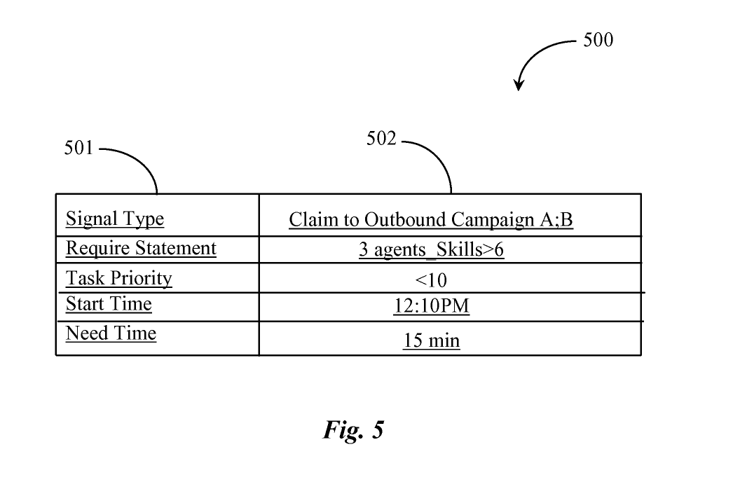

FIG. 5 is a table 500 illustrating a message that might be sent to lay claim to one or more agent resources working on a lower priority task in the contact center. Table 500 represents a logical construction of a claim signal designed to communicate a need for human resources. Table 500 has a column 501 listing five parameter types that quantify the human resources needed to solve a problem like sudden spike in traffic, for example.

Table 500 has a column 502 that lists the values by rows associated to the five parameters listed in column 501. Reading from top down and from left to right in both columns 501 and 502, the table lists the signal type, which is described as a claim for resources sent to outbound campaigns A and B. A require statement is simply a statement of the number of human resources claimed and the minimum skills level that those claimed agents must posses to qualify for reassignment according to this particular claim. In this case the claim signal value for require statement is 3 agents with skills rating greater than 6.

A task priority indication in column 501 defines the level of priority of a task that agents may be released from in order to fulfill the require statement. In this case the priority level is less than 10 meaning that no agents should be pulled from current tasks that have a priority level of 10 or greater. A start time is indicated and in the associated value column is listed as 12:10 PM. The start time indicates the time that the claimed agents will be needed to answer calls. A need time is the final parameter of the claim signal and the associated value is 15 minutes. In one embodiment a list of available (logged on) agents is provided with indication of the preferred agents that are to be reassigned. In this embodiment the subsystem that will release agents may have the final say over which agents will be reassigned. In another embodiment the subsystems have no control over claimed agents and the agents claimed must be reassigned for the expected period.

In one embodiment of the present invention, a claim signal does not specify where a claimed agent will come from. In this case the receiving subsystems may respond with candidates that they can release from their current duties. In such communication the claiming system may be allowed to pick the agents and the agents may be distributed over more than one interaction-processing subsystem.

It will be apparent to one with skill in the art that the workforce management application of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A workforce-management application resident on a digital medium for reallocating human resources between two or more interaction-processing subsystems in a contact center comprising:
a state-monitoring application executable from the digital medium for monitoring the current volumes of interaction requests pending in all of the currently active subsystems;
a logic function executable from the digital medium by the state-monitoring application, the logic function adapted to determine what specific human resources with the required skills are needed to satisfy the current interaction processing requirements; and
a communication and notification function for communicating the determinations of the logic function between one or more subsystems and for notifying individual ones of the affected human resources about the activity changes before they are set to occur.

2. The workforce-management application of claim 1 wherein the interaction-processing subsystems include at least one subsystem dedicated to processing unsolicited inbound interaction requests and one or more subsystems dedicated to processing inbound requests resulting from an outbound campaign.

3. The workforce-management application of claim 1 wherein the human resources are skilled contact-center agents.

4. The workforce-management application of claim 2, wherein the one or more subsystems dedicated to processing inbound requests resulting from an outbound campaign is an outbound telephone campaign.

5. The workforce-management application of claim 1, wherein the digital medium is coupled to an interaction request-distribution server.

6. The workforce-management application of claim 2, wherein the subsystem dedicated to processing inbound interaction requests is a telephone switch that is computer telephony integrated (CTI) and enhanced for routing by a routing server.

7. The workforce-management application of claim 1, wherein the incoming interaction requests are calls arriving to the contact center from a Website on Internet and from the Public-Switched-Telephone-Network (PSTN).

8. The workforce-management application of claim 2, wherein the incoming interaction requests are one-on-one chat requests arriving from a Website.

9. The workforce-management application of claim 2, wherein the outbound interaction requests are proactive outbound chat requests from the contact-center to a Website.

10. A method for reallocating human resources from servicing one interaction-processing subsystem to service another interaction-processing subsystem in a contact center comprising the steps:
(a) monitoring the states of the active interaction-processing subsystems in the contact center;
(b) detecting an irregularity in state of one or more of the interaction-processing subsystems;
(c) determining the numbers and skills requirements relative to reallocate-able human resources in the contact center that would be required to correct the irregularity or irregularities detected in step (b); and,
(d) communicating the determination of (c) to the appropriate interaction-processing subsystem or subsystems as a request and notifying the individual ones of the human resources to be reallocated of the pending activity changes before they occur.

11. The method of claim 10 wherein one subsystem is dedicated to processing inbound interaction requests and one or more subsystems are dedicated to processing interaction requests resulting from an outbound campaign.

12. The method of claim 10 wherein the human resources are skilled contact-center agents.

13. The method of claim 10 wherein in step (a) monitored state includes the current numbers of pending interaction requests queued for processing by human resources under that subsystem.

14. The method of claim 10 wherein in step (b), the irregularity is a sudden or predicted increase in volume of inbound interaction requests arriving at the contact center.

15. The method of claim 10 wherein in step (c), the determination is made by logic against a set of business rules and statistics available about reallocate-able human resources.

16. The method of claim 11 wherein the subsystem dedicated to processing inbound interaction requests is a telephone switch that is computer telephony integrated (CTI) and enhanced for routing by a routing server.

17. The method of claim 10 wherein the one or more subsystems dedicated to processing outbound interaction requests is an outbound telephone campaign.

18. The method of claim 10 wherein in step (d), the communication is brokered by a statistics server.

19. The method of claim 10 wherein the incoming interaction requests are calls arriving to the contact center from a Website on the Internet and from the Public-Switched-Telephone-Network (PSTN).

20. The method of claim 10 wherein the incoming interaction requests are one-on-one chat requests arriving from a Website.
